(19) United States
(12) Patent Application Publication
(10) Pub. No.: US 2017/0197650 A1
(43) Pub. Date: Jul. 13, 2017

(54) CARRYING DEVICE

(71) Applicant: Jean Whistler, Toronto (CA)

(72) Inventor: Jean Whistler, Toronto (CA)

(21) Appl. No.: 15/386,773

(22) Filed: Dec. 21, 2016

(30) Foreign Application Priority Data
Jan. 7, 2016 (CA) 2916835

(51) Int. Cl. B62B 3/14; B62B 5/00

(52) U.S. Cl. CPC B62B 3/1472; B62B 5/0083

(57) ABSTRACT

The invention relates to a device for carrying (or hanging) one object on another object especially where they are mobile objects. In particular the device will enable a person to carry a personal wheeled buggy on, for example, a grocery shopping cart, while shopping in a market.

The carrying device has a rod like member defining a pair of generally parallel legs, respective first and second leg ends defined by the legs, a transverse rod member extending between the first ends of the legs, respective open circular wound attachment loops on the second end of each leg, the attachment loops having free ends, and the attachment loops being resilient for fitting their free ends onto a portion of a personal wheeled appliance.

### FIELD OF THE INVENTION

The invention relates to a device for carrying a personal wheeled buggy on, for example, a grocery shopping cart, enabling that person to shop in the store, collect items in the shopping cart, and after check out to transfer goods from the shopping cart and place them in the personal wheeled buggy.

### BACKGROUND OF THE INVENTION

Many persons shopping collect items in a shopping cart, for example, and then after checking out they remove them from the shopping cart and carry them to their car, or walk home, with the goods in bags. For an increasing number of persons this process is simply not practical whether from personal preference, or due for example to age or a handicap, a person may find it inconvenient, or in fact impossible, to carry shopping bags. Such persons often rely on some form of personal wheeled buggy. The bags of groceries are removed from the shopping cart and are then placed in the buggy and wheeled home, or to a car. When not in use the buggy is usually capable of being put away for storage, or to be placed in the trunk of a vehicle, for example.

When in the store and while using a shopping cart such persons must somehow carry or drag their personal buggy around beside them or place the buggy in the in-store shopping cart. Leaving the buggy unattended while shopping with the shopping cart is not an option.

The invention provides a convenient carrying device by which the buggy can be suspended on and carried by the shopping cart. While shopping, and placing items in the shopping cart, the personal buggy is not required and it is simply “parked” on the edge of the shopping cart. In this way, after checking out, the buggy can be released and the goods transferred from the shopping cart, or from the counter, into the buggy, leaving the shopping cart behind in the store for use by other customers.

There may be many other situations of a generally similar nature, where the buggy is temporarily an encumbrance, but in which the buggy must be kept in the possession and control of its owner, until it is required for its usual function.

For example, it may be desirable to carry such a buggy on a infant stroller, or on a handicapped persons wheelchair, or in a transit vehicle.

In some cases, for example in a class room, office, or restaurant, it may be desirable hang the buggy nearby, on a stationary object.

For the purposes of this application, and for sake of simplicity, the term “carrying” is deemed to include applications in which the buggy is temporarily supported whether for carrying or hanging or otherwise.

### BRIEF SUMMARY OF THE INVENTION

With a view to providing a device applicable to these situations for use with a personal wheeled appliance, the invention provides a removable carrying device, attachable to a personal wheeled appliance or buggy, and comprising a rod like member defining a pair of generally parallel legs, each defining respective first and second ends, a transverse rod portion extending between said first ends of the legs, a semi-arcuate wound attachment member on the second end of a first leg, a semi-arcuate wound attachment member on the second end of a second leg, each of said attachment members defining free ends, said attachment members each being resilient and adapted to be sprung open for fitting over a portion of a personal wheeled appliance.

The device will has with upper ends which are additionally bent into more or less semicircular arches defining, in section, a wide mouthed downwardly open channel and in which the transverse rod portion extends between the ends of the respective legs forming the arches.

Preferably the legs, at least, can be squeezed together to enable them to be fitted to a buggy. In this way the device is held on the buggy but can be swung up or down dependent on need.

The legs at their second ends are twisted into more or less circular loops formed by twisting each of the second ends of each of the legs into open form more or less circular windings. The windings are directed along axes in opposite directions, apart from one another, and each encircle between about 300 and 360 degrees. The ends of the windings define open spaces, which will enable the user to manipulate them around a cross member or frame portion of a bag buggy.

The upper ends of the legs are bent into arches extending away from a first side of the legs, substantially parallel to one another.

The circular windings on the second ends of the legs extend from sides of the legs opposite to the direction of the arches on the first ends of the legs

The transverse rod portion may have a somewhat enlarged section, possibly being formed by a sleeve of alternate material.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective of a carrying device illustrating the invention;

FIG. 2 is a top plan of the device of FIG. 1;

FIG. 3 is a side elevation of the device of FIG. 1;

FIG. 4 is a is an end elevation of the device of FIG. 1;

FIG. 5 is a schematic illustration showing a frame portion of a personal bag buggy, with the device of FIG. 1 attached, swung up in use, and showing the rear portion of a regular shopping cart on which the buggy is supported.

### DESCRIPTION OF A SPECIFIC EMBODIMENT

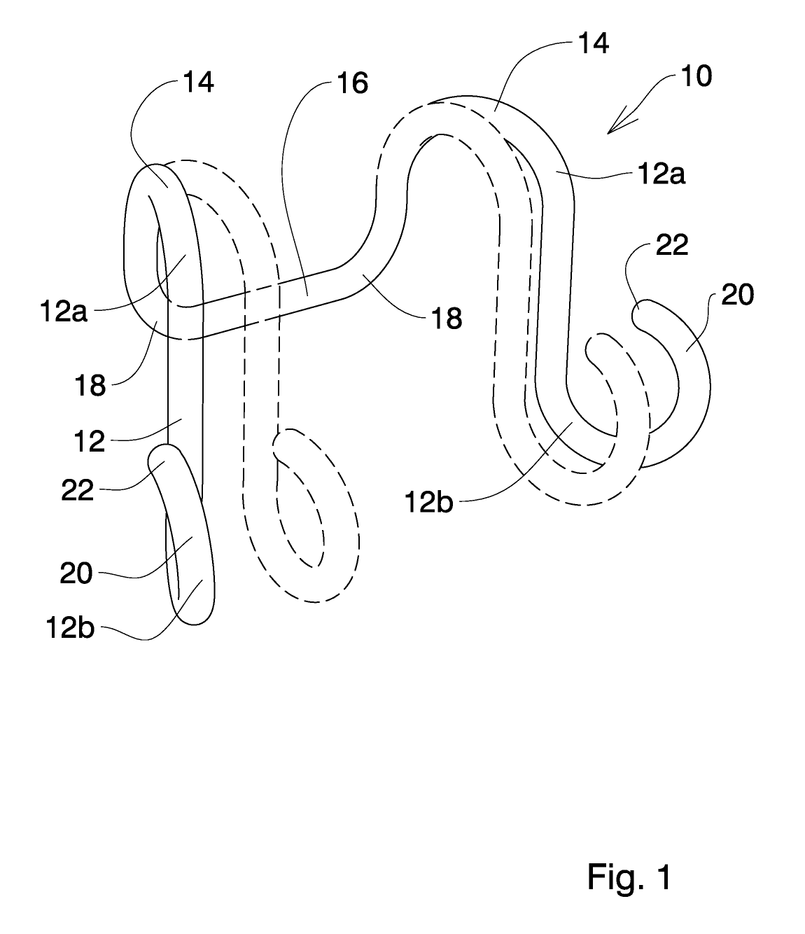

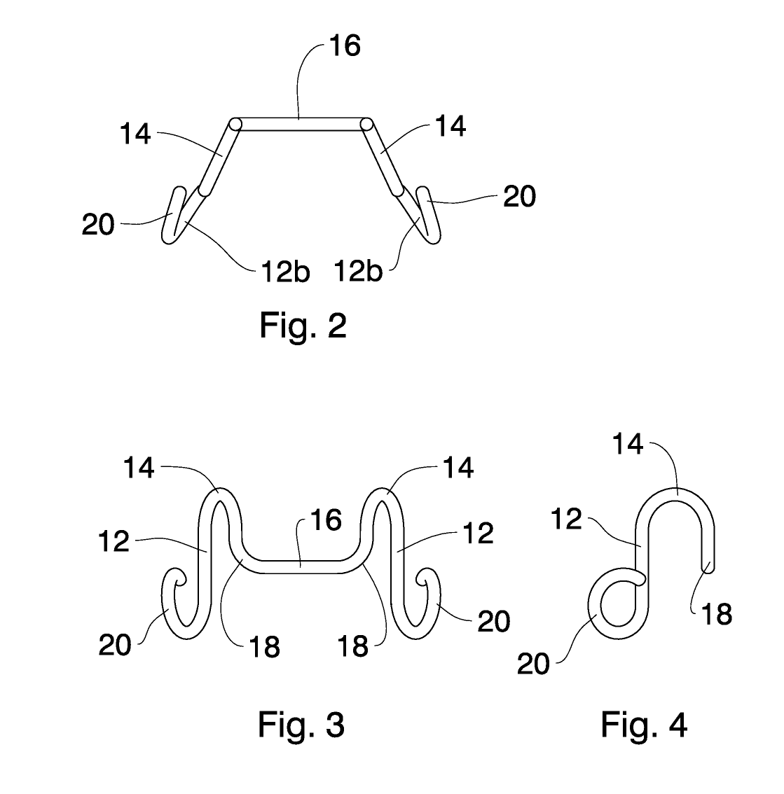

Referring first to FIG. 1 it will be seen that there is illustrated a carrying device generally indicated as (10).

Throughout this description reference is made to a personal bag buggy. Such buggies are very well known and require no illustration. They may be made of metal and some include bags of cloth. They have two, or in some cases more, wheels. A user can trail this buggy along when going shopping, collect shopping bags and return home, or to the car.

This enables persons to transport multiple shopping bags, without having to hold them in the hands.

The device of the invention is to be attached to the buggy. It will enable the user to carry the buggy on the edge of a market shopping cart, typically on the rear edge, or to hang the buggy elsewhere to keep it out of the way.

The device in this embodiment, is typically formed of a length of rod, typically metal rod or synthetic material, of suitable gauge. The choice of material may vary between metal and synthetic plastic, or a combination of them, depending upon the use intended, and the weight of the object to be carried. Clearly other forms of manufacturing can be used, such as injection moulding and the like, where demand warrants the investment.

The device (10) has first and second legs (12) which are essentially parallel to one another, or diverge slightly to provide a resilient action.

The legs (12) have respective first and second ends (12a) and (12b).

At first ends (12a) the legs (12) are formed into generally semi circular arches (14).

Between the semi circular arches (14) of the first ends (12a) of the legs a generally transverse rod portion (16) is formed.

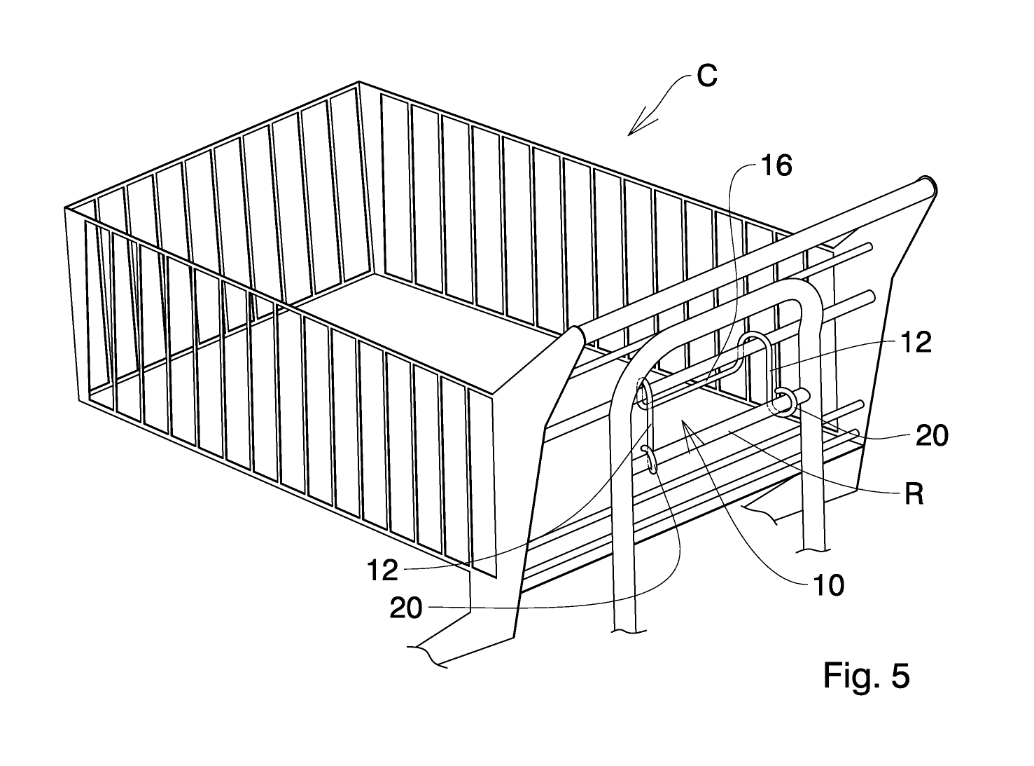

Transverse rod portion (16) is preferably formed by more or less right angular corners (18) at the first ends of the arches (16) of the legs. Arches (14) define an internal diameter which is wide enough to fit over a suitable portion of, for example, a shopping cart edge, or any other convenient place, such as is shown in FIG. 5, simply for the sake of clarity.

In this way a generally downwardly open channel is formed, by the arches (14) between legs (12) and transverse rod portion (16).

The transverse rod portion (16) may have an enlarged cross section, (not shown) possibly being formed by a sleeve (not shown) of alternate material encasing the transverse portion.

The legs (12), at their respective second ends (12b) are formed with generally open semi-arcuate or helical shaped loops or windings (20). Loops (20) are formed as twisted or windings or partial helixes. The windings are twisted with respective right and left hand rotations, and have central axes directed along a line extending more or less normal to the axis of their respective legs (12) The windings will encircle up to about a full circle or somewhat less than a full circle, typically each encircling between about 300 and 360 degrees, and terminate at free ends (22). Typically they may have a diameter of between about 1 and 2 inches, or at least adequate to be fitted around the handle of the typical bag buggy

The upper ends of the legs are bent into the arches (16) and extend away from a first side of the legs (12a) and (12b), substantially parallel to one another.

The circular windings (20) on the second ends of the legs (12a) and (12b) extend away from sides of the legs opposite to the direction of the arches (16) on the first ends of the legs.

Each free end (22) defines spacing between itself and the adjacent portion of its respective leg. This enables a user to manipulate each winding loop onto a cross bar or frame portion of a personal bag buggy.

Once attached the windings or loops form rotatable attachments. The device can then simply hang down when not required.

In use, (FIG. 5), the device can be rotated up so that the transverse rod portion is upper most. It can then be hooked over the edge of a typical shopping cart in a market.

The legs (12) are formed of resilient material which can either flex together or flex apart depending upon the buggy to which they are attached. When released the legs will exert a resilient spring action returning to their original position, thus enhancing their attachment to the buggy. By manipulating the winding loops (20). The loops can be wrapped around a buggy rail portion (R). This will secure the device (10) to the buggy, in a rotatable manner. The winding loops (20) provide a hinging or swing action and permit the device to hang down, when not required, or the device can be rotated up, enabling the arches (14) and the transverse rod portion (16) to be engaged over the edge, or rail, at the rear of a shopping cart C, between the cart handles, or any other location such as that described above, (FIG. 5).

In this way the device can be engaged by hooking the arches (14) onto or over any suitable portion of some adjacent structure whether it be a shopping cart, or a wheelchair, or a chair back, or a hand rail on for example public transit, or similar location. When so engaged the device will suspend the buggy, leaving the owner with free hands to attend to any other function, eg pushing the shopping cart, selecting items to be purchased, enjoying a meal, or the like. The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A carrying device for use with a personal wheeled buggy appliance, of the type having a handle by which the buggy can be rolled along by a person, and comprising;
a rod like member defining a pair of generally parallel spaced apart legs; respective first and second leg ends defined by said legs, said legs being resilient and adapted to be moved together and apart;
arches formed at said first ends of said legs defining a downwardly open channel;
a transverse rod portion extending between said arches on said first ends of said legs;
a first wound attachment loop on said second end of a first said leg, said first attachment loop defining a respective free end;
a second wound attachment loop on said second end of a second said leg, said second attachment loop defining a respective free end;
each of said attachment loops defining an arc of at least 300 degrees, and being resilient and adapted to be sprung open for fitting said loops onto a portion of a said personal wheeled buggy appliance,
and wherein said arches on said first ends of said legs are bent extending away from a first side of said legs, substantially parallel to one another, and wherein said winding loops on said second ends of said legs extend from sides of said legs opposite to the direction of said arches on said first ends of said legs.

2. The device as claimed in claim 1 wherein each of said arches of said legs is bent into more or less a semicircle defining, in section, a wide mouthed downwardly open channel.

3. The device as claimed in claim 2 wherein said transverse rod portion extends between said arches on said first ends of respective said legs.

4. The device as claimed in claim 3 wherein said legs are operable to be squeezed together to enable the device to be fitted to a buggy.

5. The device as claimed in claim 4 wherein said device is adapted to be secured on the buggy and is swingable up and down dependent on need.

6. The device as claimed in claim 5 wherein each of said leg second ends have respective attachment loops formed by twisting respective ends of respective said legs into open form circles, said loops being directed outwardly, apart from one another, defining respective right and left hand rotations, and each encircling between about 300 and 360 degrees.

7. The device as claimed in claim 6 wherein each said loop has a free end defining a space between itself and its respective leg.

8. The device as claimed in claim 7 wherein said transverse rod portion has an enlarged section.
